(19) United States
(12) Patent Application Publication
(10) Pub. No.: US 2013/0292189 A1
(43) Pub. Date: Nov. 7, 2013

(54) Virtual Weight Meter

(71) Applicant: Mingsheng Liu, Omaha, NE (US)

(72) Inventor: Mingsheng Liu, Omaha, NE (US)

(21) Appl. No.: 13/886,954

(22) Filed: May 3, 2013

Related U.S. Application Data
(60) Provisional application No. 61/642,725, filed on May 4, 2012.

(51) Int. Cl. G01G 11/04

(52) U.S. Cl. CPC G01G 11/04
USPC 177/1; 177/119

(57) ABSTRACT

A system and method for calculating the weight of a load over a conveyor belt system. The method comprises placing a material that has a weight onto a conveyor belt, moving the conveyor belt at a desired speed, and calibrating a weight meter to solve for the coefficients of a polynomial equation. The method then comprises operating the motor drive to send a desired power supply signal to the motor. The motor drive sends command signals to the motor to move the conveyor belt at the desired speed. The weight meter inputs the power supply and speed signal data as well as the coefficients calculated in the calibration into a polynomial regression formula to calculate for the mass of a load on the conveyor belt in which mass is a function of the power and speed. The weight meter outputs the mass calculation to the other system components.

### CROSS-REFERENCE TO RELATED APPLICATIONS

This application claims the benefit of U.S. Provisional Patent Application Ser. No. 61/642,725 filed on May 4, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Technical Field

The disclosed embodiments generally relate to calculating the weight of a load, and, more particularly, to calculating the weight of a load on a moving conveyor belt system.

2. Discussion of Prior Art

A conveyor is a transport device often used in the mining, manufacturing, and transportation industries. It is often desirable in the stated industries to know with accuracy the weight of loads traveling on a conveyor system. Typical conveyor belt systems include one or more idlers connected mechanically to one or more load cells with an endless belt looped around the idlers and the head and tail pulleys. One of the pulleys is driven so that the belt is continuously moving over the idlers. An electric motor is commonly used as the prime mover of a conveyor belt system, or any portions therein.

The prior art includes several devices and methods to detect the weight of a load on a conveyor belt. In much of the prior art the process of weighing materials is accomplished through modifications of or additions to the conveyor belt system itself. U.S. Pat. No. 4,260,034 to George J Randolph Jr., is an installed apparatus for measuring the weight of loads on a conveyor belt involving an elongated roller carried on an elongated axle. Each axle end is received within a different one of two spaced axle supports. A deformation detector is connected to each support and generates an electrical signal directly related to the force carried through the support. The detectors are connected in a circuit which produces a composite output signal directly related to the vertical force only carried through both supports. The apparatus detects the load weight by rejecting all forces other than that created by the load weight on the conveyor belt. U.S. Pat. No. 7,750,253 B2 to Gary Wineland is a scale and method for weighing loads on a conveyor belt. A generator is included that receives mechanical energy arising from movement of the conveyor belt and outputs electrical energy that corresponds to a rate of movement of the conveyor belt. At least one load cell receives electrical energy from the generator, senses the weight of the load, and outputs a voltage that corresponds to the weight of the load and the rate of movement of the conveyor belt.

In other prior art, a sensing device in connection with a control device is used to detect the weight of a load on a conveyor belt system. U.S. Pat. No. 6,621,014 B1 to Tanner et al. is a variable speed load sensitive produce and sorting conveyor system that uses a sensing device to sense the weight of loads and adjust the speed of the conveyor according to the weight. A control unit receives and calculates information corresponding to a load weight and varies the speed of the motor and/or hydraulic device coupled to the mechanical devices translocating the load. U.S. Pat. No. 8,067,704 to Lowe et al. includes an apparatus that can measure the weight of a load at a weighing zone over a span of the conveyor in which the conveyor speed is increased or decreased depending on the measured weight.

Ideally, a system would be devised that can measure the weight of a load over the entire span of the conveyor without the need for modifications to the conveyor belt system. However, at the current time there is no known method or system which accomplishes this objective. Therefore, it is an object of an embodiment of the proposed system to provide an improved system for measuring the weight of a load on a conveyor belt system over the entire span of the conveyor.

Finally, it is an objective of an embodiment of the proposed system to provide an improved system for measuring the weight of a load on a conveyor which is relatively simple and straightforward in design, and is safe, efficient, and effective in use.

### SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

In one embodiment, a virtual weight meter system for calculating the weight of a load is provided. The virtual weight meter system is comprised of a virtual weight meter, a conveyor system, and a communication bus linked in communication with said virtual weight meter and conveyor system. In an embodiment, the conveyor system may for example comprise a conveyor belt having at least one belt drive mechanism or motor which drives the conveyor belt. The conveyor system may also comprise a motor drive that controls the supply of power to include, for example, the voltage, current, and frequency to the motor. The motor drive may be a variable frequency drive (VFD), a servo, or inverter but is not limited to those previously stated herein. The conveyor system is just an example of an embodiment of a possible conveyor system that may be linked in communication with the virtual meter.

The communication bus is configured with a communication protocol to communicate data wirelessly or by wire between the motor, motor drive, virtual weight meter, conveyor system, and/or any connected external devices. The communication protocol may, for example, include CAN, Modbus, BACnet, or 12C but is not limited to those stated types. In an embodiment, a variety of external devices can be configured to be communicable and exchange data with the virtual weight meter system to include a pump, fan, motor, and/or compressor. Zero, one, or a plurality of external devices may be configured to communicate with the virtual weight meter system at any one time.

One embodiment of the virtual weight meter comprises a display, keypad, and at least one communication port. The at least one communication port is configured to enable communication between the virtual weight meter, communication bus, external devices, and the conveyor system to include the motor drive, motor, and conveyor belt. A connecting wire, USB, or other communicative or data storage devices may for example be plugged into the at least one communication port to configure the meter parameters, perform maintenance procedures, download or upload data, and communicate with other devices but are not limited to the functions stated herein. The at least one communication port may for example be a serial, parallel, USB port, RS232, Ethernet, and/or CAN port but are not limited to the previously stated types. The communication bus is configured to communicate with and send information to and from the virtual weight meter, motor drive, and/or any external devices.

An embodiment may include a method of calculating for the weight of a load on a moving conveyor belt system. A method may include placing a material that has a weight onto a conveyor belt and moving the conveyor belt at a desired speed. The method includes calibrating the virtual weight meter to solve for the coefficients of the equation m=ax2+bx+c. After calibration, the method includes starting the virtual weight meter and operating the motor drive to send a desired power supply signal comprising a voltage, current, and frequency to the motor. The motor drive sends command signals to the motor to move the conveyor belt at the desired speed. The communication bus inputs the collected power supply and speed signals from the conveyor system to the virtual weight meter to be processed into another digital format. In the method, the collected data may be converted to a unit system that is readable by the weight meter. In the method, the weight meter inputs the power supply and speed signal data as well as the coefficients calculated in the meter calibration into a polynomial regression formula such as m=ax2+bx+c, where x=power/speed to calculate for the mass of a load on the conveyor belt. The stated regression formula is not limited to the one stated and is just an example of a 2nd order equation that can be used. The relationship can be regressed to any order of polynomial equation to include but not limited to a linear, power, or exponential equation. The method may then include re-converting the units of the mass calculation. The method also includes an output processing method where information is digitized into a format readable to the other system components and/or external devices. In the method, the virtual weight meter outputs the mass calculation to the other system components of the virtual weight meter system and/or external devices. The method for mass calculations continues in a loop format.

The above-described features and advantages of the present disclosure thus improve upon aspects of those systems and methods in the prior art designed to calculate for a weight of a load on a moving conveyor belt system.

### BRIEF DESCRIPTION OF THE DRAWINGS

It will be appreciated that for simplicity and clarity of illustration, elements illustrated in the following figures have not necessarily been drawn to scale. For example, the dimensions of some of the elements are exaggerated relative to other elements for clarity. Advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a schematic diagram of the system embodying the principles of the invention used for calculating the weight of loads on a conveyor belt system.

FIG. 2 is a flowchart showing the decision-making processes of the virtual weight meter system embodying the principles of the invention used for calculating the weight of loads on a conveyor belt system.

FIG. 3 is a perspective view showing a preferred embodiment of virtual weight meter 105 according to the present invention.

### DRAWINGS REFERENCE NUMERALS

50 Virtual Weight Meter Display
55 Virtual Weight Meter Keypad
60 Communication Ports
100 Virtual Weight Meter System
105 Virtual Weight Meter
110 Conveyor Belt
115 Motor
120 Motor Drive
145 Communication Bus
200 Flow Diagram of Weight Calculation Method
210 Start Module
220 Communication Input Module
230 Input Processing Module
240 Unit Conversion Module
250 Mass Calculation Module
260 Reverse Unit Conversion Module
270 Output Processing Module
280 Communication Output Module

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

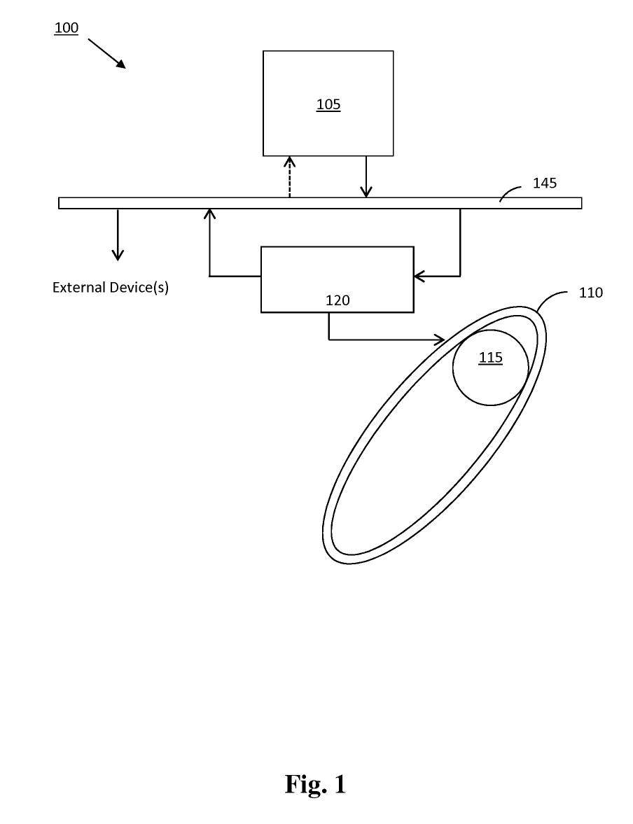

In accordance with one embodiment, a virtual weight meter system 100 is illustrated in FIG. 1. In the embodiment, virtual weight meter system 100 is comprised of a virtual weight meter 105, a communication bus 145, and a conveyor system. Although the virtual weight meter 105 is applied to a conveyor in the illustrated embodiment, the system may be applied to several mechanical devices or systems. Virtual weight meter 105 communicates with the conveyor system via communication bus 145. The conveyor system may for example comprise conveyor belt 110 having at least one belt drive mechanism or motor 115 which drives the conveyor belt 110 around a set of pulleys. A pulley may be any type of a pulley, roller, gear, or any type of wheel including at least one groove in which any type of rope, cable, chain, or belt may run such that when the pulley is moved or turned, the rope, cable, chain, or belt will also move or rotate in the same direction. Motor 115 may include, for example, a DC or AC motor connected to the discharge end pulley. Motor 115 may, however, be connected to the system at any other location. If motor 115 is an AC motor, it may be a one-phase or three-phase motor. Also, there may be multiple motors, each for example driving a separate pulley that may be synchronized to turn the multiple pulleys and distribute the load accordingly. In operation, for example, the motor 115 drives the pulley which, in turn, produces a motion in the belt 110 so that material deposited on the top surface of the belt 110 is transported in a direction toward the discharge end. The conveyor system may also comprise a motor drive 120 that controls the supply of power to include, for example, the voltage, current, and frequency to motor 115. Motor drive 120 may be a variable frequency drive (VFD), a servo, or inverter but is not limited to those previously stated herein. The previously described conveyor system is just an example of a possible conveyor system that may be linked in communication with virtual meter 105. Other types of conveyor systems or roller assemblies may also be used.

Communication bus 145 is configured with a communication protocol to communicate data wirelessly or by wire between motor 115, motor drive 120, virtual weight meter 105, the conveyor system, and/or external devices. The communication protocol may, for example, include CAN, Modbus, BACnet, or 12C but is not limited to those stated types. In an embodiment, at least one external device can be configured to be communicable and exchange data with virtual weight meter system 100 at any one time. The stated external devices may for example include at least one pump, fan, motor, and/or compressor, but the external devices are not limited to those stated herein. There may be only one external device or a combination of devices. In another embodiment, no external devices are configured to communicate with virtual weight meter system 100.

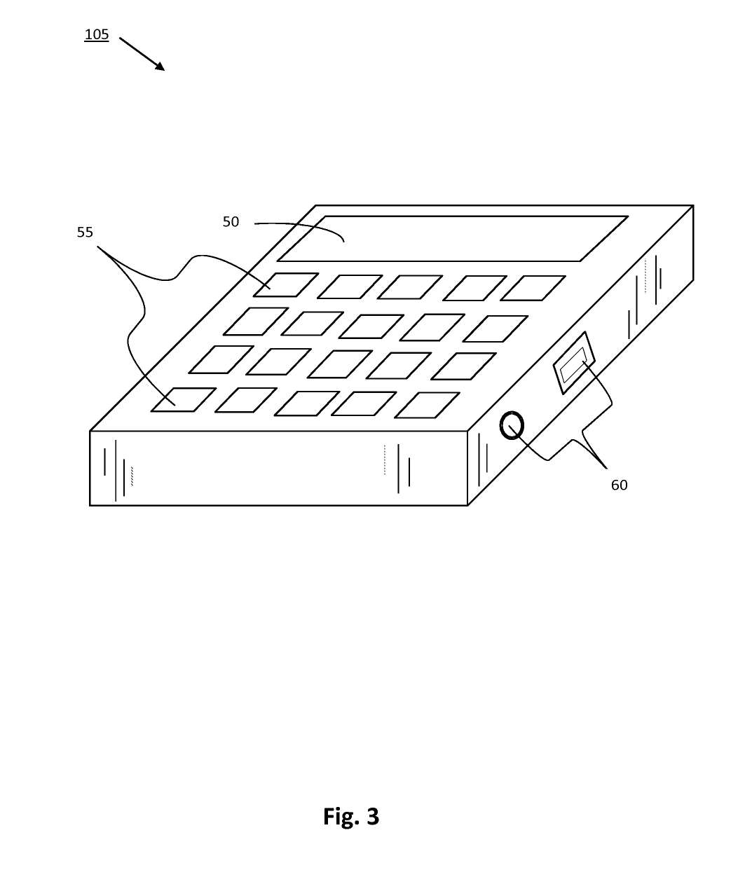

FIG. 3 gives a perspective view of an embodiment of virtual weight meter 105 comprising a display 50, keypad 55, and communication ports 60. Communication ports 60 is configured to enable communication between virtual weight meter 105, communication bus 145, external devices, and the conveyor system to include motor drive 120, motor 115, and conveyor belt 110. Connecting wire, USB, or other communicative or data storage devices may for example be plugged into communication ports 60 to configure the meter parameters, perform maintenance procedures, download or upload data, and communicate with other devices but are not limited to the functions stated herein. Communication ports 60 may for example be a serial, parallel, USB port, RS232, Ethernet, and/or CAN port but are not limited to the previously stated types. Communication bus 145 is configured to communicate with and send information to and from virtual weight meter 105, motor drive 120, and/or any external devices. Notably, virtual weight meter 105 is not limited to the configuration and design illustrated in FIG. 3. For example, another embodiment of virtual weight meter 105 may include at least one communication port, at least one display, and at least one keypad.

Virtual weight system 100 may be calibrated using any standard method of calibration, such as, for example, material calibration. In a material calibration, different materials are weighed at one speed or one material is weighed at different speeds on the conveyor belt and this data is sent to a computation apparatus. Thus, a method of calibrating virtual weight system 100 may, for example, involve placing materials of differing weights on conveyor belt 110 and modifying the speed of said belt at differing speeds using motor 115 and motor drive 120. The collected weight and speed data from the stated speed and weight tests may be downloaded or entered manually using keypad 55 to virtual weight meter 105. Using the collected power,speed, and weight values from the stated tests, virtual weight meter 105 calculates for the coefficients of the following equation for which mass equals a function of the power and speed:

M=ax²+bx+c

where x=power/speed.
Notably, the previously stated regression formula is not limited to the one stated and is just an example of a 2^{nd} order equation that can be used. The relationship can be regressed to a polynomial equation of any order to include a linear, power, or exponential equation.

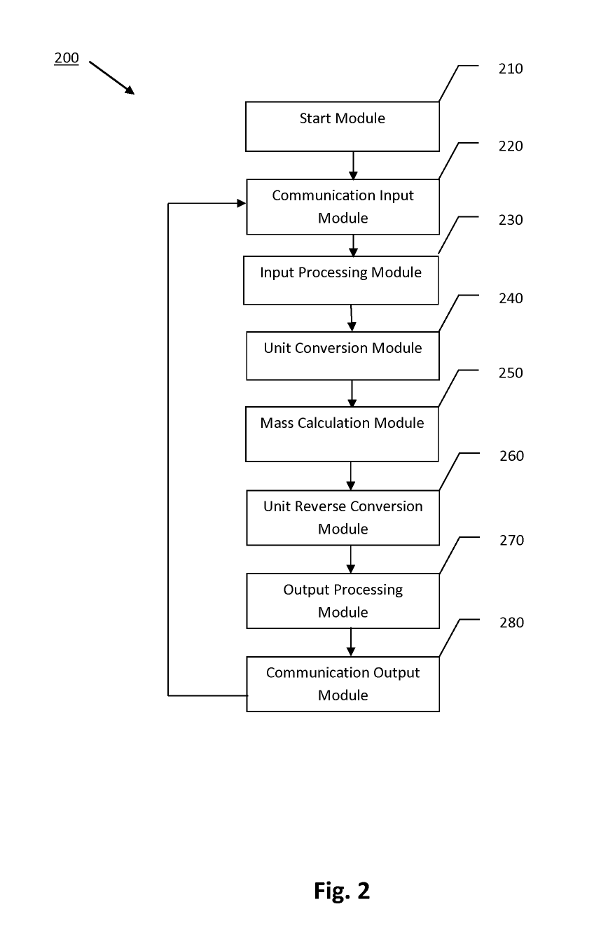

An embodiment of a method for finding the weight of material on a moving conveyor belt using virtual weight meter 105 is depicted by flow diagram 200 in FIG. 2. The method may include placing a material that has a weight onto conveyor belt 110. A method 210 may include starting virtual weight meter 105 and operating motor drive 120 to send a desired power supply signal comprising a voltage, current, and frequency to motor 115. Motor drive 120 sends command signals to motor 115 so that motor 115 moves conveyor belt 110 at a desired speed. In a method 220, communication bus 145 transmits the collected power and speed signals from the motor drive of the conveyor system to virtual weight meter 105. In a method 230 virtual weight meter 105 processes these input signals into another digital format.

A method 240 may include a unit conversion between SI units and US customary units or other unit system so that virtual weight meter 105 reads the communicated power and speed data. A method 250 may include virtual weight meter 105 calculating for the weight of a material on conveyor belt 110 using the data from the calibration and the processed power supply and speed data. More specifically, weight meter 105 calculates for the mass of a load on conveyor belt 110 by inputting the power and speed information communicated from the conveyor system and the known coefficients collected from the calibration into a polynomial regression formula where, for example, M=ax²+bx+c, and x=power/speed. Notably, the specific regression formula employed is not limited to the one given herein and is just an example of a 2^{nd} order equation that can be used. The relationship can be regressed to any order of polynomial equation to include but not be limited to a linear, power, or exponential equation. A method 260 may include a unit conversion between SI units and US customary units or other unit system so that the mass calculated in method 250 can be communicated to the conveyor system and/or at least one external device. In a method 270, virtual weight meter 105 processes the data into a form readable by communication bus 145. In a method 280, virtual weight meter 105 outputs the calculated mass of a load to communication bus 145. Communication bus 145 communicates the mass of a load to the conveyor system and/or external device 125. The stated method with which virtual weight meter 105 may calculate for the weight of a load on conveyor belt 110 continues in a loop as illustrated in FIG. 2. The programming of virtual weight meter 105 is not detailed in this disclosure but is known to a person of ordinary skill in the art.

What is claimed is:

1. A method of calculating the weight of at least one load on a conveyor belt system having a conveyor belt, motor drive, and motor, said method comprising:
calibrating a weight meter based on said conveyor belt system for a plurality of coefficients of a polynomial equation for which mass is the function of the speed and power of said conveyor belt system;
placing said at least one load onto said conveyor belt, wherein said at least one load has a weight value;
sending, by said motor drive, a power supply signal and a speed command signal to said motor;
driving, by said motor, said conveyor belt at a desired speed based on said power supply signal and said speed command;
connecting a communication bus in communication with said conveyor belt system and said weight meter;
inputting, by said communication bus, said power supply and speed signal into said weight meter;
inputting, by said weight meter, said plurality of coefficients, said power supply signal, and said speed signal into said polynomial equation;
calculating, by said weight meter, said weight of said at least one load based on said polynomial equation;
outputting, by said weight meter, said weight of said at least one load to said communication bus;
outputting, by said communication bus, said weight of said at least one load to said conveyor belt system.

2. The method of claim 1, wherein calibrating said weight meter based on said conveyor belt system and said at least one load further comprises:
placing said at least one load onto said conveyor belt system, wherein said at least one load has a weight value;
moving said conveyor belt system at a desired speed value;
inputting said speed value and said weight value into said weight meter; and
calculating, by said weight meter, a plurality of coefficients for said polynomial equation.

3. The method of claim 1, wherein inputting, by said weight meter, said plurality of coefficients, said power supply signal, and said speed signal into said polynomial equation further comprises converting, by said weight meter, said speed signal and said power supply signal to a format readable by said weight meter.

4. The method of claim 1, wherein outputting, by said weight
meter, said weight of said at least one load to said communication bus further comprises converting, by said weight meter, said weight to a format readable by said communication bus.

5. The method of claim 1, wherein said polynomial equation is a linear equation.

6. The method of claim 1, wherein said polynomial equation is a power equation.

7. The method of claim 1, wherein said polynomial equation is an exponential equation.

8. The method of claim 1, wherein said motor drive is a variable frequency drive.

9. A meter system for weighing at least one load on a conveyor belt, said meter system comprising:
a conveyor belt system, said conveyor belt system comprising:
at least one conveyor belt, said at least one conveyor belt operable to transport said load, said load having a weight;
at least one motor configured in communication with and able to drive said conveyor belt at a desired speed value; and
at least one motor drive configured in communication with and operable to send a desired power value to drive said motor;
a calculation apparatus configured in communication with said conveyor belt system, said calculation apparatus comprising:
an input module, said input module operable to input said speed and power values from said conveyor belt into a polynomial equation for which mass equals a function of said power and speed values;
a calculation module operable to solve for the mass of said polynomial equation; and
an output module operable to output said mass to said conveyor belt system.

10. The meter system of claim 1, further comprising a communication bus configured in communication with said at least one motor drive and calculation apparatus, said communication bus operable to transmit said power value and speed value to said calculation apparatus and said mass value to said conveyor system.
